(19) United States
(12) Patent Application Publication
(10) Pub. No.: US 2012/0027033 A1
(43) Pub. Date: Feb. 2, 2012

(54) MULTI-SEGMENT ALL-FIBER LASER

(75) Inventors: Fritz Henneberger, Oranienburg OT Lehnitz (DE); Axel Schülzgen, Winter Park, FL (US); Hans-Jürgen Wünsche, Berlin (DE)

(73) Assignees: The Arizona Board of Regents on Behalf of The University of Arizona; HUMBOLDT-UNIVERSITAT ZU BERLIN

(21) Appl. No.: 13/262,568

(22) PCT Filed: Mar. 21, 2010
(86) PCT No.: PCT/EP2010/002176

§ 371 Date: Sep. 30, 2011

Related U.S. Application Data
(60) Provisional application No. 61/211,860, filed on Apr. 2, 2009.

(51) Int. Cl. H01S 3/067

(52) U.S. Cl. 372/6

(57) ABSTRACT

A multi-segment all-fiber laser is provided. The device includes a first active fiber laser segment, a first grating, a second grating, and a gain-phase coupling fiber segment arranged between the first and second gratings, said gain-phase coupling segment providing coupling of gain and phase between said first and second gratings.

### BACKGROUND OF THE INVENTION

The invention relates to a multi-segment all-fiber laser device and method for generating optical pulses and/or pulse trains.

The compactness, ruggedness, high beam quality, and efficiency of fiber lasers make them attractive devices for applications in optical communications, signal processing and sensing as well as in medicine and industry. In recent years, much effort has been directed towards the development of pulsed fiber lasers based on Q-switching and mode-locking. Pulsed fiber lasers can be low-cost and low-maintenance alternative light sources for conventional pulsed solid-state lasers.

In traditional pulsed fiber lasers mode-locking and Q-switching are achieved through external, bulk optical elements such as saturable absorbers or acousto-optic and electro-optic modulators (B. C. Collins K. Bergman, S. T. Cundiff, S. Tsuda, J. N. Kurz, J. e. Cunningham, W. Y. Jan, M. Koch, and W. H. Knox, “Short cavity erbium/ytterbium fiber lasers mode-locked with a saturable Bragg reflector”, IEEE J. Sel. Top. Quantum Electron. 3, 1065 (1997); G. P. Lees, D. Taverner, D. J. Richardson, and L. Dong, “Q-switched erbium doped fibre laser utilising a novel large mode area fibre”, Electron. Lett. 33, 393 (1997))

These bulk elements make the laser design rather complex. Alternatively, mode-locked fiber ring lasers with linear polarizers or figure-eight fiber lasers with nonlinear interferometry have been demonstrated. While the first two categories lose the many advantages of an all-fiber format, the second pair of configurations suffer from stability problems. Importantly, none of the all-fiber approaches allow for an externally controlled, adjustable repetition rate.

There also exists the effect of self-pulsing in fiber lasers in cavities free from active modulation or passive mode-locking devices that have been reported more than a decade ago (J. L. Zyskind, V. Mizrahi, D. J. DiGiovanni, and J. W. Sulhoff, “Short single frequency erbium-doped fiber laser”, Electron. Lett. 28, 1385 (1992); P. Le Boudec, M. Le Flohic, P. L. Francois, F. Sanchez, and G. Stephan, “Self-pulsing in Er3+-doped fiber laser”, Opt. Quantum Electron. 25, 359 (1993).

These self-pulsation phenomena are based on instabilities and can generally be classified as either sustained self-pulsing (SSP) or self-mode-locking (SLM) (F. Fontana, M. Begotti, E. M. Pessina, and L. A. Lugiato, “Maxwell-Bloch modelocking instabilities in erbium-doped fiber lasers”, Opt. Commun. 114, 89 (1995)).

SSP is the periodic emission of laser pulses at a repetition rate associated with relaxation oscillations. It is enhanced at particular pumping rates and by low cavity photon lifetimes. SSP is generally considered a detrimental effect in high-power fiber lasers because in combination with stimulated Brillouin scattering it leads to the emission of intense irregular pulses.

SML involves laser signal modulations at a period corresponding to the cavity round-trip time and can typically be observed close to the laser threshold. Therefore, any self-pulsation occurs either at the rate of the relaxation oscillations (typically a few hundred Hz to a few hundred kHz in fiber lasers) or the inverse cavity roundtrip time (typically a few MHz to 1 GHz depending on the fiber laser cavity length) and can neither be easily controlled nor manipulated.

### OBJECTIVE OF THE PRESENT INVENTION

Accordingly, the objective of the present invention is to provide a method and system which is capable of emitting well-defined optical pulses and/or pulse trains of well-defined but adjustable wavelength.

### BRIEF SUMMARY OF THE INVENTION

An embodiment of the invention relates to a multi-segment all-fiber laser device including: a first active fiber laser segment; a first grating; a second grating; and a gain-phase coupling fiber segment arranged between the first and second gratings, said gain-phase coupling segment simultaneously providing coupling of gain and phase between said first and second gratings.

The first and second gratings may be distributed feed-back grating structures.

Preferably, the first grating is located in the first active fiber laser segment, and the second grating is preferably located in a second active fiber laser segment. Accordingly, the gain-phase coupling segment may be positioned between both active fiber laser segments.

The gain-phase coupling segment may comprise a passive optical fiber of specific length, and/or an active fiber having a variable optical gain depending on the optical power of a pump radiation, and/or a nonlinear optical fiber with an intensity dependent refractive index.

The gain-phase coupling segment is preferably connected to a control pump source for providing pump radiation in the gain-phase coupling segment. A gain-phase control unit may control the optical power of pump radiation provided by the control pump source. This allows adjusting the gain and/or phase in said gain-phase coupling segment in order to maintain or enable gain-phase coupling between the gratings.

Furthermore, the first active fiber laser segment and/or the second active fiber laser segment may be pumped by a single or a plurality of pump sources in order to provide population inversion in those active fiber laser segments.

The multi-segment all-fiber laser device may further comprise a temperature control unit which is connected to the gain-phase coupling segment. The temperature control unit may control the temperature and thus the refractive index of the gain-phase coupling segment.

An embodiment of the invention further relates to a method of emitting optical pulses and/or pulse trains, including the steps of:
activating a first active fiber laser segment of a multi-segment all-fiber laser device to emit radiation;
at least partially reflecting the radiation between a first grating of said multi-segment all-fiber laser device and a second grating of said multi-segment all-fiber laser device; and
adjusting a gain-phase coupling fiber segment arranged between the first and second gratings in order to simultaneously couple gain and phase between said first and second gratings.

According to a preferred embodiment the temperature of the gain-phase coupling fiber segment is controlled in order to maintain or enable gain-phase coupling between both gratings.

Moreover, if the gain-phase coupling fiber segment includes an active fiber having a variable optical gain depending on the optical power inside, the active fiber will preferably be pumped in order to adjust the optical gain of the active fiber and to maintain or enable gain-phase coupling between both gratings.

The method may also include the step of regulating the output power of the first active fiber laser segment in order to control the refractive index of a nonlinear optical fiber included in said gain-phase coupling fiber segment.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended drawings. Understanding that these drawings depict only typical embodiments of the invention and are therefore not to be considered to be limiting of its scope, the invention will be described and explained with additional specificity and detail by the use of the accompanying drawings in which

FIG. 1 shows an exemplary embodiment of a multi-segment all-fiber laser device having two active fiber laser segments;

FIG. 2 depicts the radiation intensity generated by the device shown in FIG. 1, over wavelength;

FIG. 3 depicts the radiation intensity generated by the device shown in FIG. 1, over frequency;

FIG. 4 depicts the intensity of radiation generated by the device shown in FIG. 1, in time domain;

FIG. 5 shows a second exemplary embodiment of a multi-segment all-fiber laser device having two temperature control units for controlling two active laser segments; and

FIG. 6 shows a third exemplary embodiment of a multi-segment all-fiber laser device having a single active fiber laser segment.

### DETAILED DESCRIPTION OF THE PREFERRED EMBODIMENT

The preferred embodiment of the present invention will be best understood by reference to the drawings, wherein identical or comparable parts are designated by the same reference signs throughout.

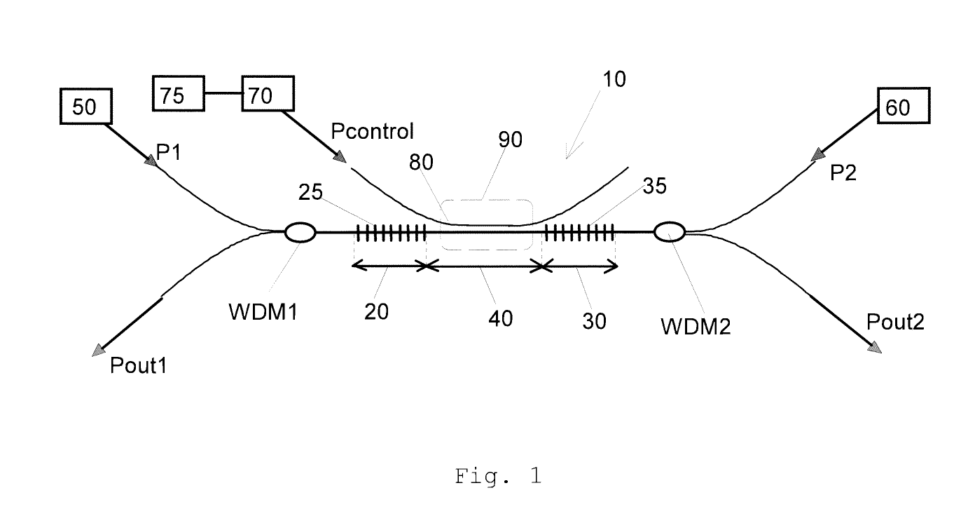

It will be readily understood that the device features of the present invention, as generally described and illustrated in the figures herein, could vary in a wide range of different device features. Thus, the following more detailed description of the exemplary embodiments of the present invention, as represented in FIGS. 1-6 is not intended to limit the scope of the invention, as claimed, but is merely representative of presently preferred embodiments of the invention.

FIG. 1 shows an exemplary embodiment of a multi-segment all-fiber laser device 10 that can emit well-defined optical pulses and/or pulse trains of well-defined but adjustable wavelength. The optical output radiation is designated by reference signs Pout 1 and Pout 2.

Device 10 comprises several segments arranged in direction along the fiber comprising a first active laser segment 20 having a first distributed feed-back grating 25, a second active laser segment 30 having a second distributed feed-back grating 35, and a gain-phase coupling fiber segment 40 arranged between the first distributed feed-back grating 25 and the second distributed feed-back grating 35. The gain-phase coupling segment provides coupling of gain and phase between gratings 25 and 35.

The embodiment shown in FIG. 1 comprises three segments; however, the device may include even more segments, e.g. more active fiber laser segments, propagation segments, grating segments, and/or nonlinear refraction segments, where these segments assume a cooperative mode of operation created by self-organization based on the gain-phase coupling of the segments. Pulse shape, duration, repetition rate, and/or pulse power may be adjusted or tuned by either the frequency detuning of the laser segments, the propagation time delays between the segments, the nonlinear phase changes induced by the segments, or by a combination of these parameters.

For generating optical output radiation preferably both fiber laser segments 20 and 30 are optically pumped to achieve optical gain. Pump signals P1 and P2 are generated by activation pump sources 50 and 60 which are connected to active fiber laser segments 20 and 30 via wavelength sensitive couplers WDM1 and WDM2.

In order to enable coupling of gain and phase between the first distributed feed-back grating 25 and the second distributed feed-back grating 35, the gain-phase coupling fiber segment 40 is preferably tunable.

E.g., the gain-phase coupling fiber segment 40 may include an active fiber having a variable optical gain depending on the optical power of a pump radiation. Alternatively or additionally, the gain-phase coupling segment 40 may comprise a nonlinear optical fiber with an intensity dependent refractive index.

For external tuning, a control pump source 70 is connected to gain-phase coupling segment 40 via an additional coupler 80. The control pump source 70 provides a pump radiation Pcontrol which is coupled into the gain-phase coupling segment 40 and which varies the optical characteristics inside the gain-phase coupling segment 40. The control pump source is controlled by gain-phase control unit 75 which is adapted to adjust the gain and/or phase in said gain-phase coupling segment 40 and to enable gain-phase coupling between the distributed feed-back gratings 25 and 35.

Device 10 may also include a temperature control unit 90 which controls the temperature of the gain-phase coupling segment 40. By controlling the temperature of the gain-phase coupling segment 40, the gain and the refractive index inside the gain-phase coupling segment 40 may also be tuned in order to enable gain-phase coupling between the distributed feed-back gratings 25 and 35.

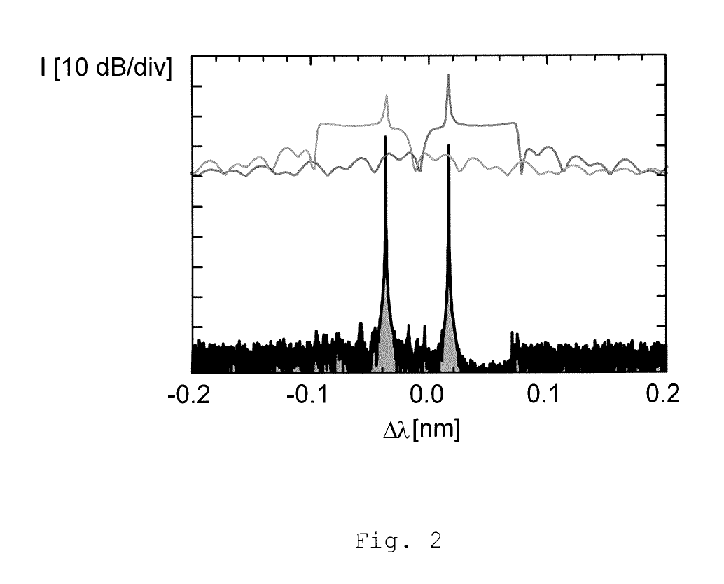

Numerical simulations of the embodiment in a wider parameter range demonstrate that the device 10 is capable of pulsed operation regimes as illustrated by the graphs shown in FIG. 2-4. The numerical simulations are based on computer programs that have been previously applied to simulate coupled semi-conductor lasers and their dynamics and are modified according to the materials parameters of phosphate glass fiber lasers (H. J. Wünsche, S. Bauer, J. Kreissl, O. Ushakov, N. Korneyev, F. Henneberger, E. Wille, H. Erzgräber, M. Peil, W. Elsässer, I. Fischer, “Synchronization of delay-coupled oscillators: A study of semiconductor lasers”, Phys. Rev. Lett. 94, 163901 (2005); S. Schikora, P. Hovel, H. J. Wünsche, E. Schöll, F. Henneberger, “All-optical noninvasive control of unstable states in a semiconductor laser”, Phys. Rev. Lett. 97, 213902 (2008)). The segment lengths l for simulation were as follows: active laser segments 20 and 30: l=3.5 cm; gain-phase coupling fiber segment 40: l=3.0 cm. The simulation assumes that the structure is homogeneously pumped along the fiber axis.

FIG. 2 depicts the intensity I of the optical radiation over the relative wavelength in nanometers. On top of the optical spectrum reflection spectra of the distributed feed-back gratings 25 and 35 are plotted.

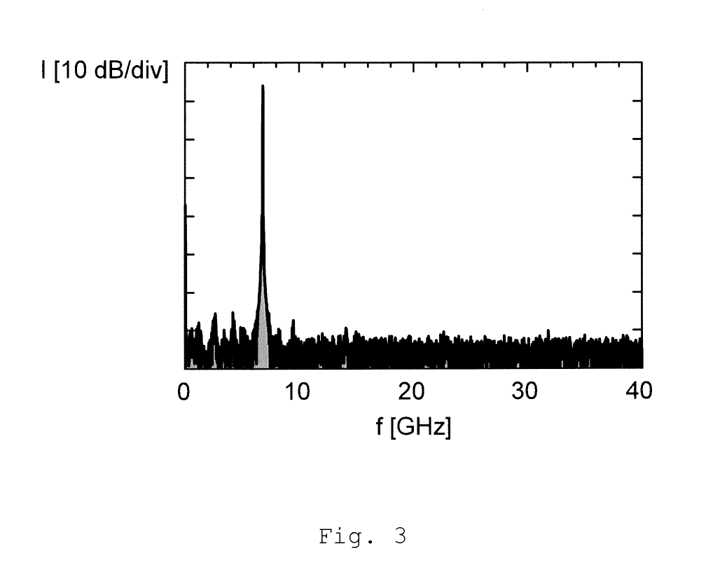

FIG. 3 depicts the intensity I of the optical radiation over the frequency in GHz.

Preferably, a gap is placed in both distributed feed-back gratings 25 and 35 in order to produce a round-trip phase shift of π/3.

The 7-GHz peak in FIG. 3 is associated with prominent and highly regular intensity pulsations in the device output with pulse duration in the sub-ns range. This is possible despite a response time of the inversion that is as long as 13 ms. The origin of this form of self-pulsing is gain coupling between the segments leading to a cooperative mode of operation of the entire three-segment device.

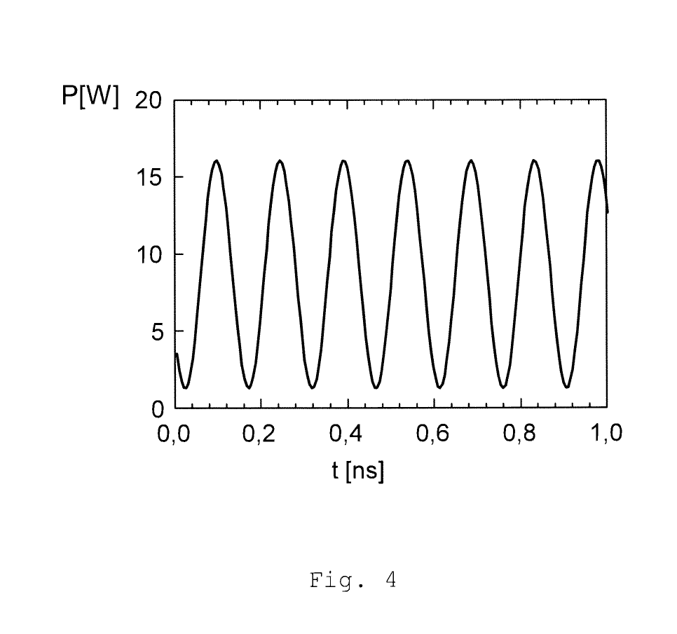

FIG. 4 shows a time-resolved laser emission from the device as shown in FIG. 1.

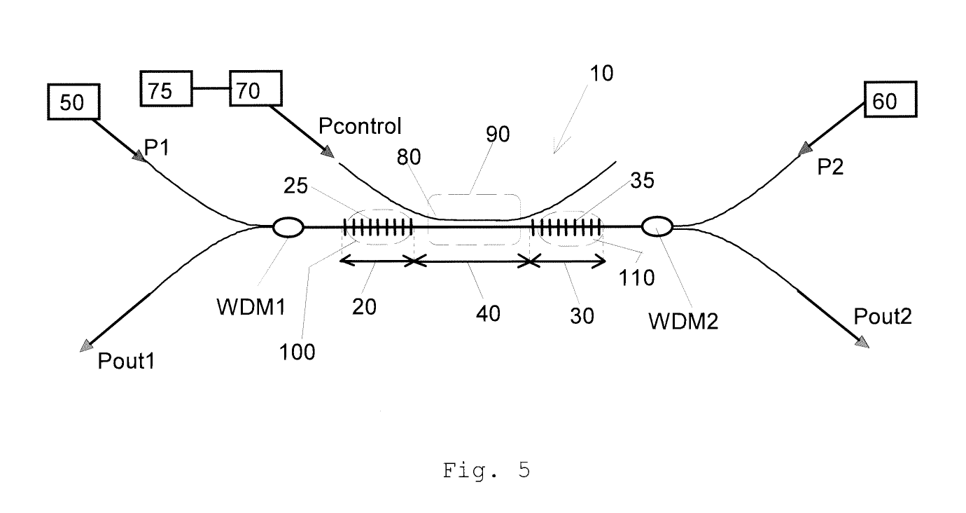

FIG. 5 depicts another embodiment of a multi-segment all-fiber laser device 10 which is capable of emitting radiation. In addition to the embodiment of FIG. 1, device 10 of FIG. 5 further comprises temperature control units 100 and 110. Temperature control unit 100 allows to control the temperature of the first active laser segment 20, whereas temperature control unit 110 allows to control the temperature of the second active laser segment 30.

With both temperature control units 100 and 110, the temperatures of the active fiber laser segments 20 and 30 can be individually regulated. Thus, these segments can also be detuned relative to each other.

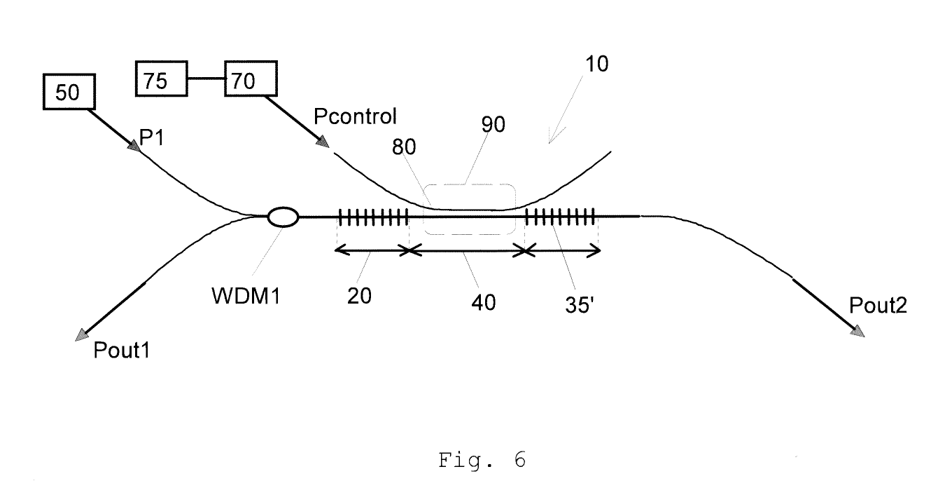

FIG. 6 depicts a third embodiment of a multi-segment all-fiber laser device 10 which is capable of emitting radiation. In contrast to the embodiments discussed above with reference to FIGS. 1-5, the embodiment of FIG. 6 comprises a single active fiber laser segment 20 and a single activation pump source 50 for generating a pump signal P1. The second distributed feed-back grating 35′ is not pumped.

In summary, the operation modes of the devices 10 as described above may include:
Pulse repetition rates can be tuned by changing the frequency detuning as well as the coupling strength between both active fiber laser segments 20 and 30.
Pulse repetition rates can be tuned by changing the optical length of the coupling fiber segment between the two DFB (DFB: distributed feed back) grating structures.
In one mode of operation, device 10 emits a stable train of optical pulses.
In another mode of operation, two pulse trains with stable phase relations can be emitted.
The frequency difference between the two pulse trains can be tuned.
The operation wavelengths of both active fiber laser segments 20 and 30 can be tuned relative to each other, e.g., by temperature tuning.
The device 10 can provide repetition rates between 100 Hz and 200 GHz, even up to 10 THz when one segment exhibits sufficiently strong Kerr-type non-linear refraction.

### REFERENCE NUMERALS

10 multi-segment all-fiber laser device
20 first active laser segment
25 first distributed feed-back grating
30 second active laser segment
35 second distributed feed-back grating
35′ second distributed feed-back grating
40 gain-phase coupling fiber segment
P1 pump radiation
P2 pump radiation
50 pump source
60 pump source
70 control pump source
75 gain-phase control unit
80 coupler
90 temperature control unit
100 temperature control unit
110 temperature control unit
Pout1 optical output radiation
Pout2 optical output radiation
WDM1 wavelength sensitive coupler
WDM2 wavelength sensitive coupler
Pcontrol pump radiation

1. Multi-segment all-fiber laser device, including:
a first active fiber laser segment;
a first grating;
a second grating; and
a gain-phase coupling fiber segment arranged between the first and second gratings, said gain-phase coupling segment providing coupling of gain and phase between said first and second gratings.

2. Multi-segment all-fiber laser device according to claim 1 wherein said first and second gratings are distributed feed-back grating structures.

3. Multi-segment all-fiber laser device according to claim 1 wherein the first grating is located in the first active fiber laser segment.

4. Multi-segment all-fiber laser device according to claim 1 wherein the second grating is located in a second active fiber laser segment.

5. Multi-segment all-fiber laser device according to claim 1 wherein said gain-phase coupling segment comprises an active fiber having a variable optical gain depending on the power of radiation transmitted therein.

6. Multi-segment all-fiber laser device according to claim 1 wherein said gain-phase coupling segment comprises a nonlinear optical fiber with an intensity dependent refractive index.

7. Multi-segment all-fiber laser device according to claim 1 wherein the gain-phase coupling segment is connected to a control pump source for providing pump radiation (Pcontrol) in the gain-phase coupling segment.

8. Multi-segment all-fiber laser device according to claim 7, further comprising a gain-phase control unit, wherein said gain-phase control unit is adapted to control the control pump source and to adjust the gain and/or phase in said gain-phase coupling segment.

9. Multi-segment all-fiber laser device according to claim 1 wherein the first active fiber laser segment and/or the second active fiber laser segment is pumped by an activation pump source.

10. Multi-segment all-fiber laser device according to claim 1 wherein the gain-phase coupling segment is connected to a temperature control unit.

11. Multi-segment all-fiber laser device according to claim 10,
wherein the refractive index of the gain-phase coupling segment is temperature-dependent; and
wherein the temperature control unit is adapted to control the temperature of the gain-phase coupling segment and to adjust the refractive index of the gain-phase coupling segment.

12. Method of emitting radiation pulses and/or pulse trains, including the steps of:
activating a first active fiber laser segment of a multi-segment all-fiber laser device to emit radiation;
at least partially reflecting the radiation between a first grating of said multi-segment all-fiber laser device and a second grating of said multi-segment all-fiber laser device; and
adjusting a gain-phase coupling fiber segment arranged between the first and second gratings in order to couple gain and phase between said first and second gratings.

13. Method of claim 12, further comprising the step of controlling the temperature of said gain-phase coupling fiber segment in order to provide gain-phase coupling between both gratings.

14. Method of claim 12,
wherein said gain-phase coupling fiber segment includes an active fiber having a variable optical gain depending on the optical power of radiation transmitted therein, and
wherein said active fiber is pumped in order to adjust the optical gain of the active fiber and to provide gain-phase coupling between both gratings.

15. Method of claim 12, further comprising the step of regulating the radiation power inside a nonlinear optical fiber included in said gain-phase coupling fiber segment and thus regulating the refractive index of the nonlinear optical fiber.
